(19) United States
(12) Patent Application Publication
(10) Pub. No.: US 2021/0178451 A1
(43) Pub. Date: Jun. 17, 2021

(54) WIRING MACHINE

(71) Applicant: MIASOLE EQUIPMENT INTEGRATION (FUJIAN) CO., LTD., Quanzhou (CN)

(72) Inventors: Fan CHEN, Quanzhou (CN); Chao HU, Quanzhou (CN); Yi SHU, Quanzhou (CN); Pengjian ZHU, Quanzhou (CN); Hongxia SUN, Quanzhou (CN); Deng PAN, Quanzhou (CN); Minghao QU, Quanzhou (CN); Xiaoning RU, Quanzhou (CN)

(21) Appl. No.: 16/080,704

(22) PCT Filed: Jun. 22, 2018
(86) PCT No.: PCT/CN2018/092488

§ 371 Date: Aug. 29, 2018

(30) Foreign Application Priority Data
Dec. 19, 2017 (CN) 201721782147.6

(51) Int. Cl. B21F 1/00; B21F 23/00

(52) U.S. Cl. CPC B21F 1/00; B21F 23/00

(57) ABSTRACT

A wiring machine includes a lever group and magnets. The lever group includes a plurality of lever arms which are spaced apart and a plurality of rotary shafts on each of which one lever arm is mounted correspondingly so as to facilitate the rotate rocking motion of the lever arms. One end of each lever arm is provided with a wire gripper and the other end is provided with an attraction head. The magnets are arranged in association with the plurality of attraction heads.

This disclosure claims priority to Chinese patent application No. 201721782147.6 filed on Dec. 19, 2017 and titled “Wiring Machine”, the entire content of which is hereby incorporated by reference.

### TECHNICAL FIELD

The present disclosure relates to, but is not limited to, the field of mechanical apparatus, in particular to a wiring machine.

### BACKGROUND

In the full-automatic wiring machine with interconnected multi-heads design, its wire-gripping heads are rocker components. As a rocker component, a wire-gripping head may rotate downwards around a rotary shaft due to the action of gravity, causing the wire-gripping head to become stuck when stacked, interrupting the normal production process.

In order to ensure that the wiring operation can be conducted continuously and efficiently, it is needed to continuously correct the rotation direction of the wire-gripping heads before the stacking in the production process so as to prevent the wire-gripping heads from getting stuck.

In conventional technology, one way to solve this problem is to stop the machine during the operation and manually adjust the machine. This will interrupt the normal production process. Another solution is to use a blowing device which prevents the wire-gripping head from rotating downward by providing upward auxiliary force generated by air flow. However, the force applied in this way is unstable and the farther the gripping head is away from the air outlet, the smaller the auxiliary force provided by the air flow will be, thus the effect cannot be guaranteed. Besides, blowing air is too noisy that the workers' hearing may be harmed.

### SUMMARY

An embodiment of the disclosure provides a wiring machine including a lever group and magnets. The lever group includes a plurality of lever arms which are spaced apart and a plurality of rotary shafts on each of which one lever arm is mounted correspondingly so as to facilitate the rocking motion of the lever arms. One end of each lever arm is provided with a wire gripper and the other end is provided with an attraction head. The magnets are arranged in association with the plurality of attraction heads.

In an exemplary embodiment, a plurality of magnets is provided.

In an exemplary embodiment, the lever group includes a first lever group and a second lever group which are spaced apart in a first direction. The wire grippers of the first lever group and the second lever group are arranged to face toward each other in the first direction, and the attraction heads are arranged to face away from each other in the first direction. The plurality of magnets are respectively positioned on the outer sides of the first lever group and the second lever group. The first direction, a second direction and a third direction are perpendicular to each other.

In an exemplary embodiment, the lever arms of the first lever group and the lever arms of the second lever group are arranged in a staggered manner in the second direction.

In an exemplary embodiment, the wiring machine further includes a conveying belt on which the lever arms are mounted via the rotary shafts. The conveying belt travels in the second direction.

In an exemplary embodiment, the conveying belt includes a first conveying belt and a second conveying belt which are spaced apart in the first direction. The first lever group is mounted on the first conveying belt, and the second lever group is mounted on the second conveying belt.

In an exemplary embodiment, the wiring machine further includes a plurality of connecting blocks which are arranged sequentially in the second direction and positioned between the first lever group and the second lever group. Each of the plurality of rotary shafts of the first lever group and each of the plurality of rotary shafts of the second lever group are respectively mounted at the ends of each of the plurality of connecting blocks.

In an exemplary embodiment, the plurality of connecting blocks are located below the conveying belt, and the rotary shaft passes through the conveying belt and rotatably mounted on the connecting blocks.

In an exemplary embodiment, the lever arm includes: a body mounted on the rotary shaft; a rocker arm rotatably mounted on the body via a rocker arm shaft, wherein the attraction head is arranged at one end of the rocker arm along the first direction, and the rocker arm is able to rock in the third direction; a gripping head fixed to the other end of the rocker arm along the first direction; and a gripping arm fixed on the body and arranged in association with the gripping head. Driven by the rocker arm, the gripping head is able to be pressed against and separated from the rocker arm.

In an exemplary embodiment, the lever arm further includes a spring connected between the rocker arm and the body for keeping the gripping head pressing against the gripping arm.

In an exemplary embodiment, the lever arm further includes a guiding member mounted on the rocker arm. The gripping head is fixed on the guiding member. The guiding member is provided with a guiding through hole extending in the third direction. One end of the gripping arm passes through the guiding through hole and presses against the gripping head. In the first direction the width of the guiding through hole is larger than the width of the gripping arm.

In an exemplary embodiment, the rocker arm shaft includes a flat head bolt and a cap nut.

In an exemplary embodiment, the gripping arm is fixed to the body via a pan head bolt.

### BRIEF DESCRIPTION OF DRAWINGS

FIG. 1 is a schematic view of a left lever group and a right lever group according to an embodiment of the present disclosure;

FIG. 2 is an exploded schematic view of the lever arm of FIG. 1;

FIG. 3 is a schematic structural perspective view of the left lever group and the right lever group in FIG. 1.

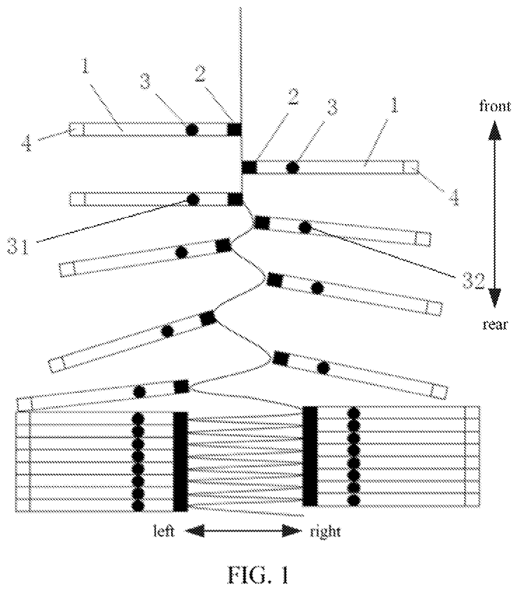

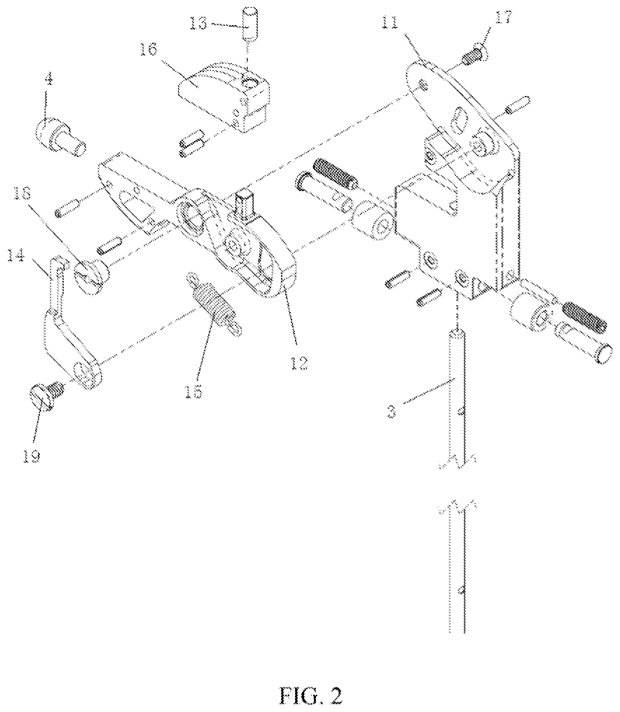

The connection between the reference number and the component in FIGS. 1 to 3 is as follows:
1—lever arm; 2—wire gripper; 3—rotary shaft; 4—attraction head; 11—body; 12—rocker arm; 13—griping head; 14—griping arm; 15—spring; 16—guiding member; 17—flat head bolt; 18—cap nut; 19—pan head bolt; 31—left rotary shaft; 32—right rotary shaft; A—connecting block.

### DETAILED DESCRIPTION

Embodiments of the present application are described in detail below, and examples of the embodiments are shown in the accompanying drawings in which the same or similar reference number denotes the same or similar element or element having the same or similar function throughout the document. The embodiments described below with reference to the accompanying drawings are exemplary and merely for explaining the present application, and should not be construed as limiting the present application.

An embodiment of the present disclosure provides a wiring machine, which includes lever groups and magnets. The lever group includes a plurality of lever arms 1 spaced apart and a plurality of rotary shaft 3. A wire gripper 2 is provided on one end of each lever arm 1, and an attraction head 4 is provided on the other end. The magnets are arranged in association with the plurality of attraction heads 4. Each of the plurality of lever arms 1 is installed on a corresponding one of the plurality of rotary shafts 3 which are configured to achieve the rocking movement of the lever arms 1.

The magnet is used for attracting the attraction head, thus keep the lever arm stable and not rotating around the rotary shaft due to gravity. Compared with the use of a blowing device, such structure has the advantage of lower noise and thus it will not do any harm to the workers' hearing.

A plurality of magnets is provided. Each of the plurality of magnets is arranged in association with a corresponding one of the plurality of attraction heads 4. The wiring machine further includes a conveying belt on which the lever arms are rotatably mounted via the rotary shafts. The lever arms can be driven by the conveying belt to move so as to be spaced apart sequentially in a second direction.

Another embodiment of the present disclosure provides a wiring machine configured for wiring, which is especially suitable for wiring operation for a solar panel. As shown in FIGS. 1 to 3, the wiring machine includes a left lever group (i.e., a first lever group) and a right lever group (i.e., a second lever group), a left conveying belt (i.e., a first conveying belt) and a right conveying belt (i.e., a second conveying belt). The left lever group and the right lever group are bilateral symmetrically arranged (i.e., symmetrically arranged in a first direction and a direction opposite to the first direction). Both the left lever group and the right lever group have a plurality of lever arms 1 spaced apart. Each lever arm 1 of the left lever group is rotatably connected to the left conveying belt via the rotary shaft 3, and each lever arm 1 of the right lever group is rotatably connected to the right conveying belt via the rotary shaft 3. The lever arms 1 of the left lever group and the lever arm 1 of the right lever group are arranged in a staggered way along the travel direction of the left conveying belt and the right conveying belt (i.e., the second direction). The left conveying belt drives each lever arm 1 of the left lever group to move in the travel direction, and the right conveying belt drives each lever arm 1 of the right lever group to move in the travel direction. A wire gripper 2 is provided on the end of the lever arm 1 of the left lever group facing toward the right lever group, and an attraction head 4 is provided on the other end of the lever arm 1. A wire gripper 2 is provided on the end of the lever arm 1 of the right lever group facing toward the left lever group, and an attraction head 4 is provided on the other end of the lever arm 1.

While driven by the left conveying belt and the right conveying belt, the wire gripper 2 of the lever arm 1 grips the wire and moves in the travel direction. The lever arm 1 of the left lever group and the lever arm 1 of the right lever group are staggered in the travel direction, and thus the wire will form a curved shape which can be a “Z” shape as shown in FIG. 1. Of course, this shape is only an example for facilitating understanding, and the wire is not limited to this shape.

Magnets are arranged on the outer sides of the left lever group and the right lever group respectively, namely, respectively arranged on the left side of the left lever group and the right side of the right lever group. The magnets attract the attraction heads 4, but they do not contact with each other.

The quantity of attraction heads 4 and the quantity of magnets are the same, and they are arranged in such a manner that one attraction head is associated with one magnet.

In one embodiment, the lever arms 1 in the left lever group are rotatably connected to the left conveying belt via the rotary shaft 3, and the lever arms 1 in the right lever group are rotatably connected to the right conveying belt via the rotary shaft 3.

That is to say, the lever arms 1 in the left lever group and the lever arms 1 in the right lever group are respectively connected to different conveying belts (i.e., the left and right conveying belts) via the rotary shafts 3 so as to be driven and operation.

In another embodiment, the same conveying belt can be used for driving function (i.e., the left and right conveying belts are one conveying belt). In order to ensure that the lever arms 1 in the left and right lever groups can move to designated positions, the rotary shaft 3 is separated into a left rotary shaft 31 on the left and a right rotary shaft 32 on the right. The lever arms 1 in the left lever group are rotatably connected to the corresponding conveying belt via the left rotary shaft 31, and the lever arms 1 in the right lever group are rotatably connected to the corresponding conveying belt via the right rotary shaft 32.

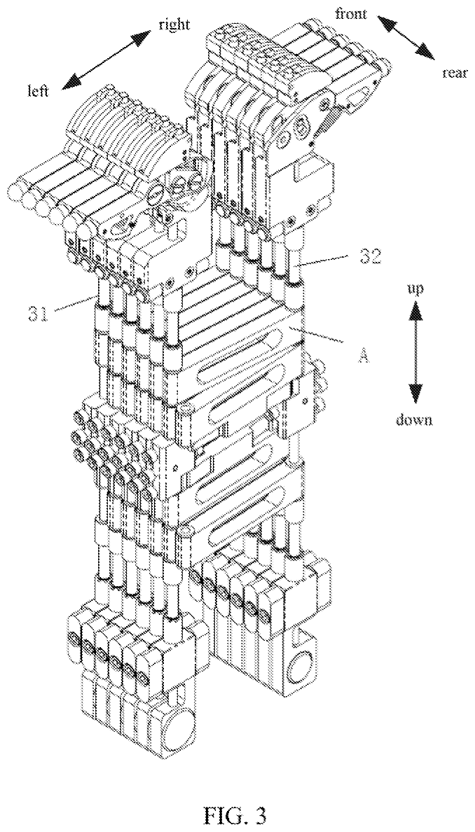

Referring to FIG. 3, the left rotary shaft 31 and the right rotary shaft 32 are spaced apart. A connecting block A is arranged between the adjacent left rotary shaft 31 and right rotary shaft 32. The two ends of the connecting block A are rotatably connected to the left rotary shaft 31 and the right rotary shaft 32 respectively. The connecting block A may be arranged below the conveying belt.

It will be understood that FIG. 3 shows only an optional embodiment, illustrating a plurality of lever arms 1 are stacked together after being driven by the conveying belt. The drawing only shows that the connection block A is used to connect the left and right rotary shafts 31 and 32, and does not limit the way of connection contemplated in the disclosure.

The conveying belt may be made of a flexible material. The left and right rotary shafts 31 and 32 may be aligned in a straight line (i.e., aligned in the front-rear direction) at the early stage of operation, while at the end stage they may be offset from each other in the front-rear direction (i.e., the second direction and the direction opposite to the second direction) due to the property of the flexible material and the rotation and guidance of the connecting block A. Alternatively, the left and right rotary shafts 31 and 32 can be directly arranged so that they are not aligned in a straight line (i.e., staggered in the front-rear direction) and directly positioned at the designated positions.

A third direction and the direction opposite to the third direction refer to the up-down direction.

The positioning shown in FIG. 1, that is, the configuration of the left and right rotary shafts 31 and 32 separated from each other, can ensure the normal operation of the lever arms 1.

Now the lever arm 1 will be described. The lever arm 1 includes a body 11, a rocker arm 12, a gripping head 13, and a gripping arm 14. The body 11 is rotatably connected to a rotary shaft 3 which of course is connected to the left conveying belt or the right conveying belt, thereby realizing the movement of the lever arm 1 of the left and the right lever groups.

The rocker arm 12 is positioned at the front side or the rear side of the body 11, and rotatably connected with the body 11 via a rocker arm shaft. The attraction head 4 is arranged at one end of the rocker arm 12 and keeps the whole lever arm 1 balanced under the attraction caused by the magnets, preventing the lever arm 1 from rotating around the rocker shaft 3 due to gravity. The rocker arm shaft may include a flat head bolt 17 and a cap nut 18 which can be screwed onto the bolt 17, facilitating the disassembly and replacement.

The gripping head 13 is fixedly arranged at the end of the rocker arm 12 away from the attraction head 4. The gripping arm 14 is positioned at the front side or the rear side of the body 11, and fixedly arranged on the body 11. The position of the gripping arm 14 corresponds to the position of the gripping head 13. When the rocker arm 12 rotates with respect to the body 11, the gripping head 13 is brought to move with it. The gripping head 13 moves toward or away from the gripping arm 14, so that the gripping head 13 and the gripping arm 14 can be closed for gripping or opened. Of course, the gripping head 13 and the gripping arm 14 can grip the wire when closed and release the wire when opened. The gripping arm 14 can be fixed to the body 11 via a pan head bolt 19. The gripping arm 14 is assembled to the body 11 without rotating relative to the body 11, via, e.g., multi-point limiting mechanism.

A spring 15 is disposed between the rocker arm 12 and the body 11. Normally, the gripping head 13 and the gripping arm 14 is in a closed and griping state. The wiring machine is also provided with a pushing member which contacts the rocker arm 12 of the lever arm 1 in the left lever group when the left and right conveying belts are moving. The rocker arm 12 rotates relative to the body 11 under the pushing action of the pushing member, causing the gripping head 13 to move away from and separate from the gripper arm 14, and causing the spring 15 to be deformed. The gripping head 13 and the gripper arm 14, being driven by the conveying belt, are located at both sides of the wire. The rocker arm 12 separates from the pushing member as the conveying belt continues to move, and under the action of the elastic force of the spring 15, the gripping head 13 moves along with the rocker arm 12 toward the gripping arm 14, which cause the gripping head 13 and the gripper arm 14 to be closed so as to grip the wire.

The lever arm 1 in the right transmission group moves in the same way as that in the left transmission group and thus the detailed description thereof is omitted.

A guiding member 16 is provided on the rocker arm 12, and the gripping head 13 is fixedly arranged on the guiding member 16. The guiding member 16 is provided with a guiding through hole extending in the up-down direction. The upper end of the gripping arm 14 passes through the through hole to be in correspondence with the gripping head 13 and pressed against the gripping head 13 under the action of the spring 15. As the guiding member 16 rocks with the rocker arm 12, the gripping arm 14 moves within the guiding through hole. The guiding member 16 is mainly used to constrain the moving direction of the gripping arm 14 so as to accurately griping the wire.

By attracting the attraction heads 4 by magnets, the stability of the position of the lever arm 1 is ensured and thus it will not rotate around the rotary shaft 3 due to gravity. Besides, compared with the prior art where the blowing device is applied, by using the magnets, noise can be reduced.

It should be understood that the above structure of the lever arm 1 is only one embodiment and is not intended to limit the present disclosure. The above-mentioned terms “left” and “right” are only used to distinguish one from another to show the structures on both sides and do not limit the specific directions or positions.

The structure, features, and effects of the present application have been described in detail in connection with the embodiments shown in the drawings. The above embodiments are only the preferred embodiments of the present application, and the scope of this application is not limited by the embodiments shown in the drawings. Changes based on the concept of the present application, or equivalent modifications made to the embodiments are within the protection scope of the present application as long as they do not depart from the spirit of the description and the drawings.

What is claimed is:

1. A wiring machine comprising a lever group and magnets, wherein the lever group comprises:
a plurality of lever arms (1) which are spaced apart, wherein one end of each lever arm (1) is provided with a wire gripper (2) and the other end is provided with an attraction head (4), and wherein the magnets are arranged in association with the plurality of attraction heads (4); and
a plurality of rotary shafts (3) on each of which one lever arm (1) is mounted correspondingly, so as to facilitate the rocking motion of the lever arms (1).

2. The wiring machine according to claim 1, wherein the lever group comprises a first lever group and a second lever group which are spaced apart in a first direction, wherein the wire grippers (2) of the first lever group and the second lever group are arranged to face toward each other in the first direction, and the attraction heads (4) are arranged to face away from each other in the first direction, wherein a plurality of magnets is provided and the plurality of magnets are respectively positioned on the outer sides of the first lever group and the second lever group, and wherein the first direction, a second direction and a third direction are perpendicular to each other.

3. The wiring machine according to claim 2, wherein the lever arms (1) of the first lever group and the lever arms (1) of the second lever group are arranged in a staggered manner in the second direction.

4. The wiring machine according to claim 2, further comprising:
a conveying belt on which the lever arms (1) are mounted via the rotary shafts (3), wherein the conveying belt travels in the second direction.

5. The wiring machine according to claim 4, wherein the conveying belt comprises a first conveying belt and a second conveying belt which are spaced apart in the first direction, and wherein the first lever group is mounted on the first conveying belt, and the second lever group is mounted on the second conveying belt.

6. The wiring machine according to claim 2, further comprising:
a plurality of connecting blocks (A) which are arranged sequentially in the second direction and positioned between the first lever group and the second lever group, wherein each of the plurality of rotary shafts (3) of the first lever group and each of the plurality of rotary shafts (3) of the second lever group are respectively mounted at the ends of each of the plurality of connecting blocks (A).

7. The wiring machine according to claim 2, wherein the lever arm (1) comprises:
a body (11) mounted on the rotary shaft (3);
a rocker arm (12) rotatably mounted on the body (11) via a rocker arm shaft, wherein the attraction head (4) is arranged at one end of the rocker arm (12) along the first direction, and the rocker arm is able to rock in the third direction;
a gripping head (13) fixed to the other end of the rocker arm (12) along the first direction; and
a gripping arm (14) fixed on the body and arranged in association with the gripping head (13), wherein, driven by the rocker arm (12), the gripping head (13) is able to be pressed against and separated from the gripping arm (14).

8. The wiring machine according to claim 7, wherein the lever arm (1) further comprises:
a spring (15) connected between the rocker arm (12) and the body (11) for keeping the gripping head (13) pressing against the gripping arm (14).

9. The wiring machine according to claim 7, wherein the lever arm (1) further comprises:
a guiding member (16) mounted on the rocker arm (12), wherein the gripping head (13) is fixed on the guiding member (16);
wherein the guiding member (16) is provided with a guiding through hole extending in the third direction, wherein one end of the gripping arm (14) passes through the guiding through hole and presses against the gripping head (13), and wherein in the first direction the width of the guiding through hole is larger than the width of the gripping arm (14).

10. The wiring machine according to claim 7, wherein the rocker arm shaft comprises a flat head bolt (17) and a cap nut (18).

11. The wiring machine according to claim 7, wherein the gripping arm (14) is fixed to the body (11) via a pan head bolt (19).

12. The wiring machine according to claim 3, wherein the lever arm (1) comprises:
a body (11) mounted on the rotary shaft (3);
a rocker arm (12) rotatably mounted on the body (11) via a rocker arm shaft, wherein the attraction head (4) is arranged at one end of the rocker arm (12) along the first direction, and the rocker arm is able to rock in the third direction;
a gripping head (13) fixed to the other end of the rocker arm (12) along the first direction; and
a gripping arm (14) fixed on the body and arranged in association with the gripping head (13), wherein, driven by the rocker arm (12), the gripping head (13) is able to be pressed against and separated from the gripping arm (14).

13. The wiring machine according to claim 12, wherein the lever arm (1) further comprises:
a spring (15) connected between the rocker arm (12) and the body (11) for keeping the gripping head (13) pressing against the gripping arm (14).

14. The wiring machine according to claim 4, wherein the lever arm (1) comprises:
a body (11) mounted on the rotary shaft (3);
a rocker arm (12) rotatably mounted on the body (11) via a rocker arm shaft, wherein the attraction head (4) is arranged at one end of the rocker arm (12) along the first direction, and the rocker arm is able to rock in the third direction;
a gripping head (13) fixed to the other end of the rocker arm (12) along the first direction; and
a gripping arm (14) fixed on the body and arranged in association with the gripping head (13), wherein, driven by the rocker arm (12), the gripping head (13) is able to be pressed against and separated from the gripping arm (14).

15. The wiring machine according to claim 14, wherein the lever arm (1) further comprises:
a spring (15) connected between the rocker arm (12) and the body (11) for keeping the gripping head (13) pressing against the gripping arm (14).

16. The wiring machine according to claim 5, wherein the lever arm (1) comprises:
a body (11) mounted on the rotary shaft (3);
a rocker arm (12) rotatably mounted on the body (11) via a rocker arm shaft, wherein the attraction head (4) is arranged at one end of the rocker arm (12) along the first direction, and the rocker arm is able to rock in the third direction;
a gripping head (13) fixed to the other end of the rocker arm (12) along the first direction; and
a gripping arm (14) fixed on the body and arranged in association with the gripping head (13), wherein, driven by the rocker arm (12), the gripping head (13) is able to be pressed against and separated from the gripping arm (14).

17. The wiring machine according to claim 16, wherein the lever arm (1) further comprises:
a spring (15) connected between the rocker arm (12) and the body (11) for keeping the gripping head (13) pressing against the gripping arm (14).

18. The wiring machine according to claim 6, wherein the lever arm (1) comprises:
a body (11) mounted on the rotary shaft (3);
a rocker arm (12) rotatably mounted on the body (11) via a rocker arm shaft, wherein the attraction head (4) is arranged at one end of the rocker arm (12) along the first direction, and the rocker arm is able to rock in the third direction;
a gripping head (13) fixed to the other end of the rocker arm (12) along the first direction; and
a gripping arm (14) fixed on the body and arranged in association with the gripping head (13), wherein, driven by the rocker arm (12), the gripping head (13) is able to be pressed against and separated from the gripping arm (14).

19. The wiring machine according to claim 18, wherein the lever arm (1) further comprises:
a spring (15) connected between the rocker arm (12) and the body (11) for keeping the gripping head (13) pressing against the gripping arm (14).

20. The wiring machine according to claim 18, wherein the lever arm (1) further comprises:
a guiding member (16) mounted on the rocker arm (12), wherein the gripping head (13) is fixed on the guiding member (16);
wherein the guiding member (16) is provided with a guiding through hole extending in the third direction, wherein one end of the gripping arm (14) passes through the guiding through hole and presses against the gripping head (13), and wherein in the first direction the width of the guiding through hole is larger than the width of the gripping arm (14).
